(19) United States
(12) Patent Application Publication
(10) Pub. No.: US 2010/0146837 A1
(43) Pub. Date: Jun. 17, 2010

(54) Fiber reinforced fishing lure

(76) Inventor: Jeff Zernov, Brainerd, MN (US)

Correspondence Address: LAW OFFICES;DOUGLAS L. TSCHIDA, Suite 202, 93 Little Canada Road West, St. Paul, MN, 55117-2369, US

(21) Appl. No.: 12/316,764

(22) Filed: Dec. 15, 2008

(51) Int. Cl. A01K 85/00

(52) U.S. Cl. 43/42.15; 43/42.08; 43/42.24; 43/42.53; 43/42.36

(57) ABSTRACT

Fishing lures constructed with internal strands of high tensile strength fibers (e.g. aramid) bonded to body pieces independent of any associated hooks. The strands are trained in appropriate alignments (e.g. longitudinally, transverse and/or radially) at high wear areas to enhance flexion and minimize tearing, especially at spanned joints. The fibers can be bonded into the body materials or anchored to the body pieces. Several soft plastic (e.g. plastisol and pvc) lures molded with resilient, durable stranded and webbed fibers enhancing durability and defining flexible joints, appendages etc. are disclosed.

### BACKGROUND OF THE INVENTION

The present invention relates to fishing lures and, in particular, to lures and a method of construction to include high tensile strength fibers (e.g. aramid, nylon) along with other lure accessory pieces (e.g. eyelets, fasteners, hooks, magnets, attractors) disposed in the lure body to prolong lure life, maintain resiliency, and improve fish catching properties.

Fishing lures have been constructed from wide ranging materials, including lead, wood, resins, plastics, and soft plastics (e.g. plastisol, pvc and other pliable, resilient, expansible and compressible plastics) and wire or combinations thereof. The lures are typically configured in one or more sections and may include bill pieces or other body parts, including filamentary appendages that define or augment body movement. Multi-section, jointed lures and soft plastic lures enhance and/or provide side-to-side or swimming movements to the lure due to the presence of mechanical joints or the resilience and flexibility of the material. Joints between body sections or appendages are typically defined by homogeneous portions of the material used to mold the lure body. Occasionally, mechanical joints typically comprising hinge assemblies, for example, a piano-type hinge, interconnected eyelets or other mating hinge/pivot pieces, are included. The interconnected hinge pieces are fastened or molded into the adjoining body sections.

Soft plastic lures with or without joints are typically molded to mimic natural bait species (e.g. alewives, minnows, crayfish, frogs, shad, salamanders, worms, insects, among many other natural fresh or saltwater baits). Some soft plastic, fresh water lures of which applicant is aware are shown at U.S. Pat. Nos. 5,815,978; 6,212,818; 7,107,719; 7,356,963; D537,911; and D542,882. The soft lure bodies typically include appendages and/or surface shapes that promote flexion during retrieval.

Smaller body size soft plastic lures can be relatively inexpensive. When damaged with use such as exposure to the sun and weather or by tearing, tooth marks and other general abrasion, the lures are typically discarded. Where larger freshwater and saltwater fish are the targeted sport fish, the lures and/or “teasers” (e.g. hook free attractors) can be rather costly (e.g. $10.00-$50.00) and damaged lures with impaired movements frequently are used beyond there effective lives.

The present invention was developed for adaptation to any size lure to provide resilient lure bodies of one or more sections that provide resilient flexion and life-like movement. The invention finds particular application with soft body or other plastic tear resistant plastic fishing lures. The lure bodies are constructed with internal strands of high tensile strength fibers (e.g. aramid, KEVLAR®, fiberglass, nylon, braided or woven fibers or other materials compatible with the material used to mold the lure body).

The strands are trained in appropriate alignments (e.g. longitudinally, transverse, radially and/or circumferentially) within the lure body and especially at high wear areas, joints, appendages or the like to minimize tearing and generally improve lure life. The fibers can be used alone or in combination with a wrapping core (buoyant or non-buoyant) or any members used to retain associated hooks, attractors or accessories to the body. The fibers may also be interconnected with any such accessories.

The reinforcement fibers find particular advantage in “swim bait” type lures which are constructed in relatively large sizes (e.g. 4 to 18 inches) to exhibit life-like movements. The bodies are molded from resilient, durable materials (e.g. plastisol, soft plastic, soft polyvinyl chloride (pvc) materials or other highly flexible materials) capable of flexing during lure retrieval. Portions of the fibers are presently wound on core pieces and trained through the molded bodies independent of mechanical joints, hook fasteners etc., although can be adapted to fasten to such accessory pieces.

### SUMMARY OF THE INVENTION

It is a primary object of the present invention to provide a fishing lure containing strands of high tensile strength fibers relative to the body material to enhance lure durability, among other improvements.

It is a further object of the present invention to provide a fishing lure containing strands of high tensile strength fibers that are trained within the body at high wear areas, joints and/or appendages susceptible to tearing, independent of any members used to retain associated hooks and other accessories to the body.

It is a further object of the invention to provide a fishing lure molded from a soft plastic containing at least one flexible joint or surface area and strands of aramid or other fibers that span the flexible lure region and are molded into the adjoining body pieces and impregnated with the molding material.

It is a further object of the invention to provide a molded fishing lure containing an array (e.g. longitudinal, transverse, radial, circumerential and/or spiral) of high tensile strength fibers that are arranged to permit body flexion and resilience and mimic lifelike movements.

It is a further object of the invention to provide a molded fishing lure containing a core piece and to which an array (e.g. longitudinal, transverse, radial, circumferential and/or spiral) of high tensile strength fibers are wound and that is arranged along with other accessory pieces (e.g. eyelets, fasteners, hooks etc.) in a fabrication mold to permit body flexion and resilience at the molded lure to mimic lifelike movements.

It is a further object of the invention to provide a molded fishing lure containing a web of high tensile strength fibers that extends within the body.

It is a further object of the invention to provide a molded plastic fishing lure containing a woven web of high tensile strength fibers that span at least one flexible joint or between adjoining body pieces to act as a hinge and/or secure the pieces together.

It is a further object of the invention to provide a molded fishing lure containing flexible appendages constructed of or containing high tensile strength fibers that are bonded to the adjoining body pieces.

It is a further object of the invention to provide a molded fishing lure containing tubular members molded into the lure body to support wire forms that for example can support a fishing line, hooks, attractors or other accessories.

It is a further object of the invention to provide a molded fishing lure containing a magnet located to retain a fish hook to the body.

The foregoing objects, advantages and distinctions of the invention, among others, are found in one presently considered lure construction, among other possible lures, that support a plurality of strands of high tensile strength materials to improve lure durability, permit body flexion and resilience to mimic lifelike movements. Molded into the lure body is a core piece having a plurality of channels, cavities, tubular appendages, bores and apertures. Strands of high tensile strength fibers (e.g. aramid, fiberglass, nylon, monofilament materials, fluorocarbon, braided or extruded fish line etc.) are wound and trained in the channels and through the appendages such that the fibers are impregnated into and/or with the molded body material. A variety of soft plastic materials (e.g. plastisol, polysilicon, soft pvc etc.) can be molded to define the lure.

Tubular pieces fitted to the core piece or molded into the lure body support wire forms and/or fasteners for eyelets and other devices that contain a fish line, hooks and other lure dressing pieces to the lure. A magnet is also molded into the core piece and located to retain an adjacent fish hook against the lure body during lure retrieval. The core piece may also be buoyant, include hollow or sound producing cavities.

Still other objects, advantages and distinctions of the invention will become more apparent from the following description with respect to the appended drawings. Considered alternative constructions, improvements or modifications are described as appropriate. The following description should therefore not be literally construed in limitation of the invention. Rather, the scope of the invention should be broadly interpreted within the scope of the further appended claims.

### BRIEF DESCRIPTION OF THE DRAWINGS

FIG. 1 shows a perspective view to an exemplary “swim bait” lure molded from a resilient, soft plastic material and wherein high tensile strength fibers are longitudinally and circumferentially supported in the lure body and appendages and span flexible joints interconnecting contiguous, adjoining body pieces to improve durability.

FIG. 2 shows a top view of the lure of FIG. 1.

FIG. 3 shows a view of the lure of FIG. 1 in partial cutaway to expose internal stranded fibers, wrapping core, tubular eyelet and hook supports, and a magnetic hook holder.

FIG. 4 shows mating mold halves and wherein one mold supports a core piece pre-wound with high tensile strength fibers and longitudinal fibers trained to span reduced thickness joints between successively contiguous body pieces.

FIG. 5 shows a perspective end view of a pre-wound core piece.

FIG. 6 shows a view of a mold supporting a core piece pre-wound with high tensile strength strands, high tensile strength webbed hinge and strand termination pieces and succeeding body core pieces that can be included, if desired.

FIG. 7 shows a view of a mold supporting a pair of core pieces pre-wound with high tensile strength strands and interconnected with woven web pieces of high tensile strength fibers that span the hinge cavities and a woven strand termination pieces.

### DESCRIPTION OF THE PREFERRED EMBODIMENT

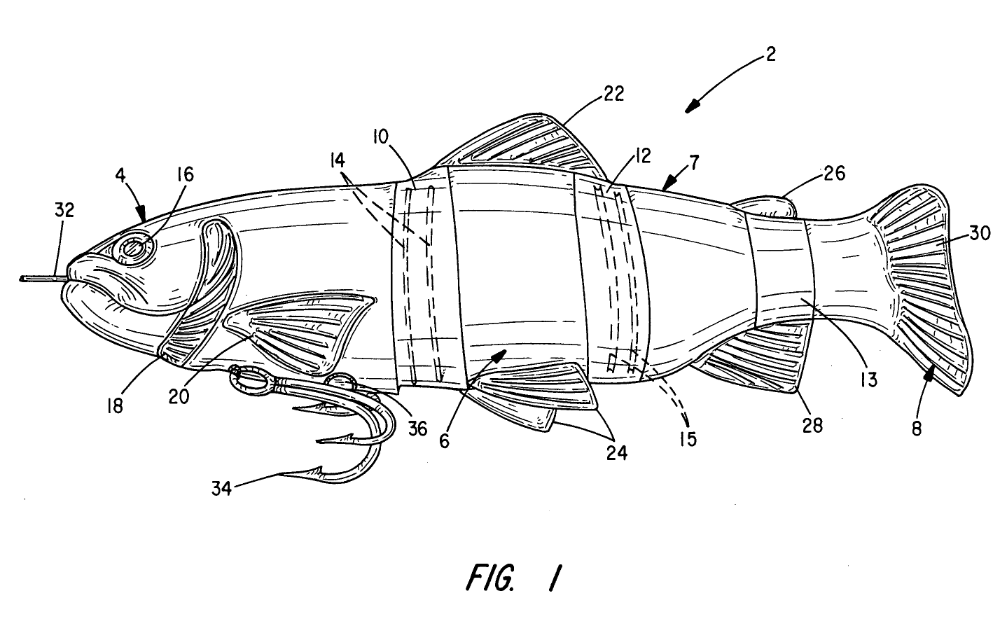

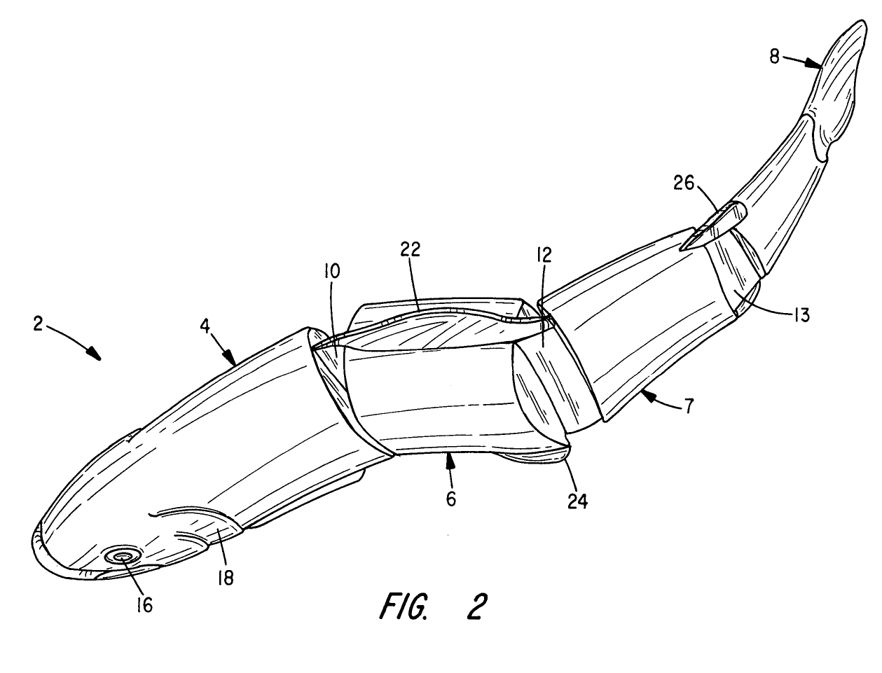

With attention to FIG. 1, a perspective view is shown to a multi-section fishing lure 2. The lure 2 is molded as a unitary assembly from a continuous pour of a homogenous soft plastic material (e.g soft polyvinyl chloride (pvc) materials, plastisol and rubber or other highly flexible, resilient mixtures). The lure 2 is molded in the form of a fish and includes a relatively thick forward head piece 4, center body pieces 6 and 7 and a tail piece 8. The center piece 6 and tail piece 8 exhibit successively thinner or tapering profiles when viewed in a top view as shown in FIG. 2.

The body pieces 4, 6 and 8 are interconnected by relatively thin, joint or hinge pieces 10, 12 and 13. The hinge pieces 10, 12 and 13 vertically span the lure 2 and are homogenously molded with the body pieces 4, 6 and 8. The material and hinged construction assure that the body and tail pieces 6 and 8 are thereby highly susceptible to lateral movement as the lure 2 is retrieved.

The hinge pieces 10, 12 and 13 each exhibit a thickness approximately ⅛ to ⅜ and no more than ½ the thickness of the body and tail pieces 4, 6, 7 and 8 as shown in the top view of FIG. 2. The thickness of the body and tail pieces 4, 6, 7 and 8 can vary as desired relative to preferred lure weight and designed hydrodynamic lure movements. The soft body material and width of the hinge pieces 10, 12 and 13 permit the body and tail pieces 6, 7 and 8 to flex side-to-side. The hinge pieces 10, 12 and 13 can be flat of can taper or flare to wider thicknesses at the junctions with the body and tail pieces 4, 6, 7 and 8. Vertical striations 14 or grooves 15 (shown in dashed line), ribs or other surface features can also be let into the hinge pieces 10, 12 and 13 to further exaggerate lateral flexion.

Molded into the head piece 4 are lifelike surface features such as eyes 16, gill plates 18 and fins 20. The center body piece 6 includes fins 22 and 24. The body and hinge pieces 7 and 13 include fins 26, 28 and the tail piece 8 includes a tail 30. The fins 22-28 and tail 30 are formed and located to facilitate a desired hydrodynamic lure motion during lure retrieval via a fish line 32. Depending upon the food specie being mimicked by the lure 2, the lure 2 can be constructed to include other body appendages such as arms, legs, claws, tentacles and the like that can be included to project from associated body pieces. The body size, surface ornamentation, coloration and other aesthetic features of the lure 2 can be varied as desired. Additional visual, audible, scent or tactile attractors or dressings can also be added, attached or embedded in the lure 2.

One or more hooks 34 are secured to the lure 2 (e.g. treble hooks). Presently, a single treble hook 34 is secured to the head piece 4. A magnetic member 36 is molded into the body piece 4 aft of the attachment point of the hook 34 and attracts the hook 34 such that the hook 34 lies against the body during lure retrieval. Grooves 37 or other surface projections or recesses at the member 36 facilitate retention of the member 36 to a core piece 42 discussed below and/or directly to the lure 2, if a core piece 42 is not used.

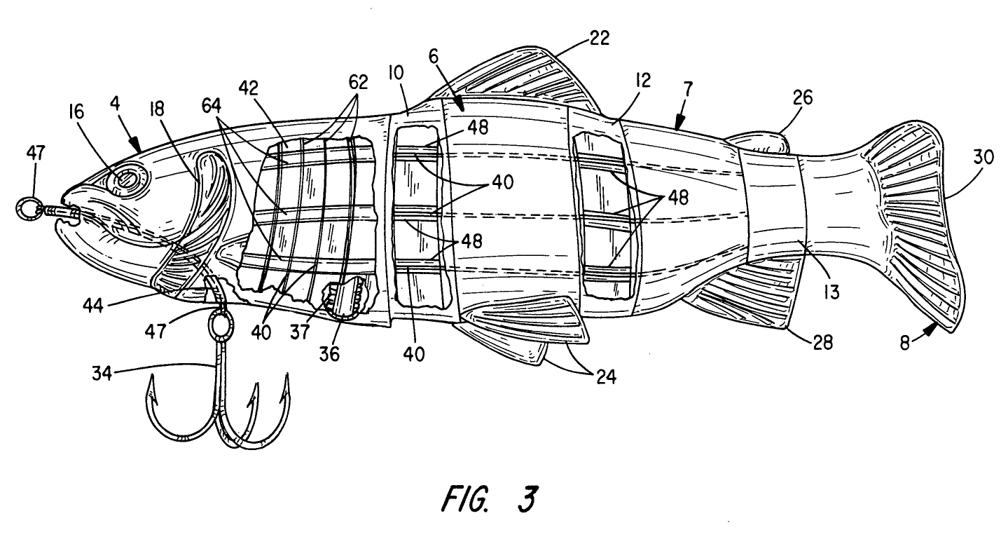

FIG. 3 depicts an enlarged view of the lure 2 in partial cutaway to expose internal, high tensile strength, stranded fibers 40, a fiber wrapping core 42, a tubular eyelet and hook wire form support piece 44, and the magnetic hook holder 36. The tubular piece 44 is typically used to provide a channel for a length of fishing line 32 that is threaded through the piece and tied to a hook 34. Alternatively and as shown at FIG. 3, during final assembly a preformed wire insert 46 can be threaded through the tubular support piece 44 after the lure 2 is molded. Twisted loop portions 47 retain the hook 34 to the lure 2 and define an eyelet to which the fishing line 32 can be attached.

The strands 40 can be embedded or directly molded into the molding material. Short tubular channel pieces 48 can also be embedded into the hinge pieces 10 and 12 and through longitudinal bores of which strands of the fibers 40 can be trained. The channel pieces 48 enhance the flexion of the hinge pieces 10, 12 and 13, since the fibers 40 are not restricted and are free to move as the hinge pieces 10, 12 and 13 move laterally.

For some lures, it may be desired to selectively bond some of the fibers 40 to the lure body pieces 4, 6, 7 and 8 and allow others to float at one or more of any provided hinge pieces 10, 12 and 13. For example, the fibers at the hinge piece 10 can be bonded directly to the hinge piece 10 and the fibers 40 at the hinge piece 12 can float in channel pieces 48. The tailored attachment of the fibers 40 permits the design of tailored lateral lure movements to preferred orientations that define desired hydrodynamic lure movements. In lieu of tubular channel pieces 44, longitudinal bores 48 may also be formed into the hinge and/or body pieces 4, 6-8, 10, 12 and 13.

The fibers 40 can exhibit a single or multi-stranded construction. For multi-stranded fiber 40, the included thread pieces can be bundled loose, twisted, woven, braided or the like. Presently a multi-stranded aramid fiber material 40 is used that exhibits a tensile strength or break resistance that is particularly susceptible to impregnation with the soft plastic body material. Such a material is especially tear resistant in comparison to the soft pvc body material used to mold the body and hinge pieces 4-13. The multi-stranded material permits the soft plastic pvc material to flow between and into the porous fibers and threads to securely integrate the fibers 40 into the lure 2. The body and hinge pieces 4-13 are thereby securely held together when exposed to tearing and twisting motions from the teeth of a predator fish and/or to other typically encountered abrading forces. Other fibrous materials (e.g. fiberglass, nylon, monofilament materials, fluorocarbon, braided or extruded fish line etc.) can also be used to advantageous effect, provided the material exhibits sufficient tensile strength, tear resistance and adhesion properties to the molding material. Many such other fiber materials may however not bond as effectively as the present pvc material.

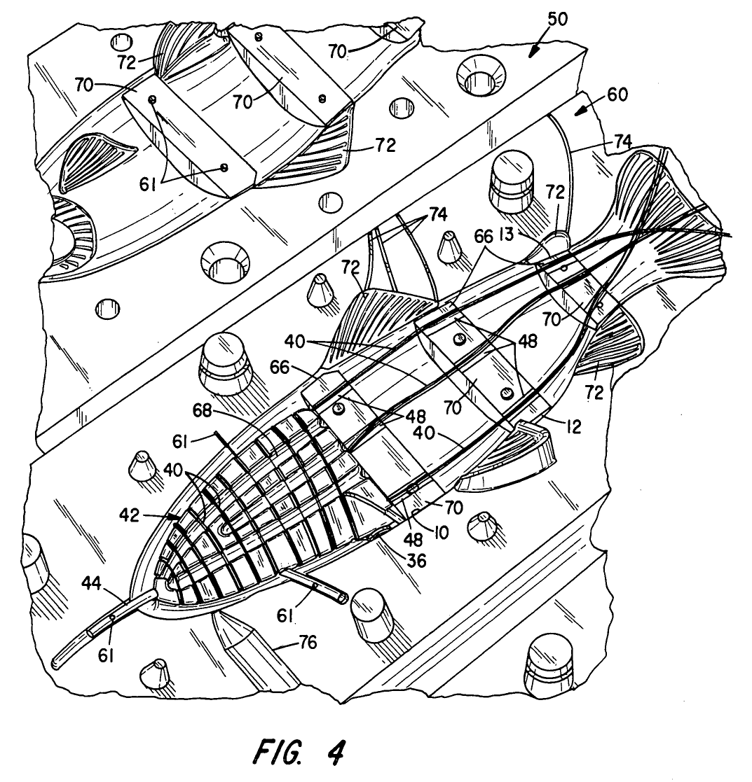

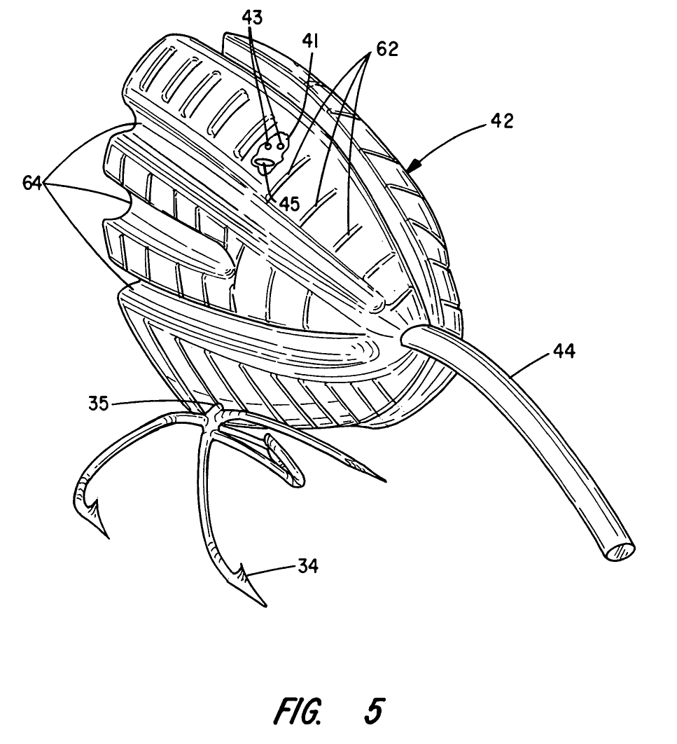

FIG. 4 shows mating mold halves 50 and 60 used to mold the lure 2. A wrapping core piece 42 and support 44 are supported in the mold half 60 with pins 61 or other suitable retainers. FIG. 5 shows a perspective view of the pre-wound core piece 42 removed from the mold halves 50 and 60. The core piece 42 is typically pre-wound with high tensile strength fibers 40. The fibers 40 are wound in spiral and longitudinal patterns as they are trained in transverse, circumferential channels 62 and longitudinal channels 64. Bores 68 in the core piece 42 allow the fibers 40 to be re-directed as necessary to achieve a desired wrapping pattern. The core piece 42 is subsequently mounted in the mold half 60 as shown.

The core piece 42 is constructed of a material compatible with the lure material such that the core piece 42 is bonded to the lure 2 and doesn't shift or separate from the body material. The density or buoyancy of the core piece 42 can be tailored to vary the buoyancy characteristics of the lure 2. For example, the core 42 be used alone or hollow air pocket(s) 41, foam piece(s) or weight(s) 43 can be added to the core piece 42 to vary the floatation characteristic of the lure 2. One or more of any hollow chambers 41 can contain the foam, weight or rattle pieces 43. Powered audible and/or tactile vibration producing pieces 45 can also be included to attract fish.

The strands 40 trailing from the core piece 42 are appropriately trained in the mold 60. Some of the strands 40 can be trained through tubular pieces 48 mounted to pedestals 66 that define the thickness of the joint pieces 10, 12 and 13 between the successively contiguous body and tail pieces 4, 6 and 8. Pieces of mold release material 70 are pinned to the pedestals 66 to facilitate release of the lure 2 once molded to form. The fibers 40 can also be trained through shaped corrugations in the release material 70 that define bores in the hinge pieces 10, 12 and 13 in lieu of tubular pieces 48. The fibers 40 are overlapped at the tail piece recess 72 such that the lure material impregnates and interconnects the fibers 40.

Appropriate relieves or recesses 72 are defined in the mold halves 50 and 60 to form the fins and tail 22-30. Channels 74 extend from the recesses 72 to allow air and material to vent and assure complete filling of the mating mold halves 50 and 60 and all the recesses 72 during molding. Fibers 40 and sprue material that extend beyond the lure molding cavities 50 and 60 are trimmed after molding. An injection or fill port 76 opens to the mold halves 50 and 60.

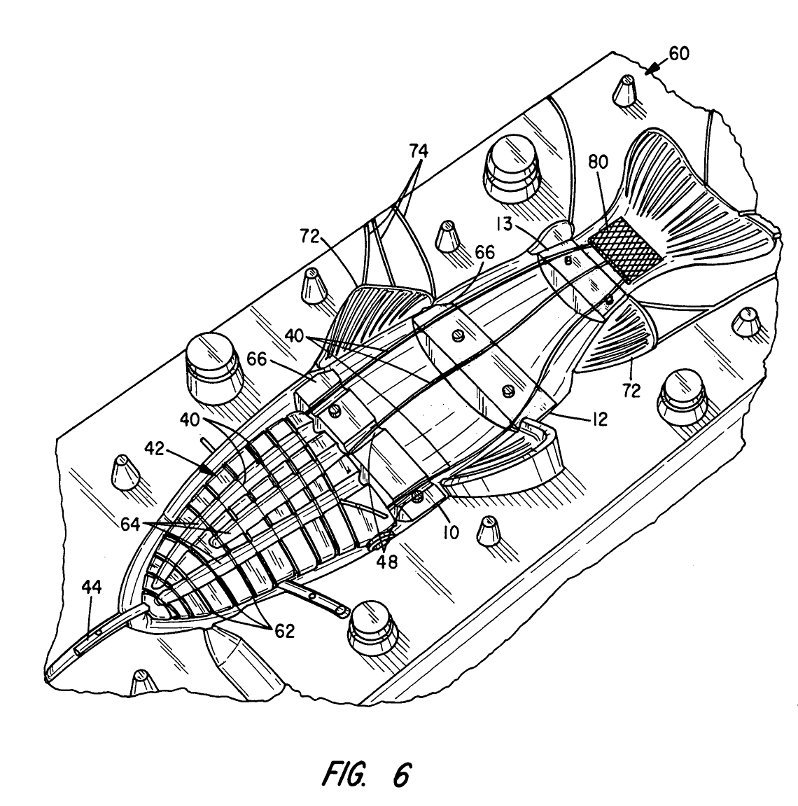

FIG. 6 shows a view of a mold half 60 that supports a core piece 42 pre-wound with high tensile strength strands 40 in substantially the same fashion as in FIG. 4. The fibers at the hinge piece 12 however are not encased in tubular members 48. A distinguishable movement pattern is thereby obtained since the fibers 40 are directly impregnated at the hinge pieces 10, 12 and 13 and the hinge pieces 10, 12 and 13 are less flexible. The fibers 40 are also bonded at a loosely woven, porous web piece 80 supported in the mold cavity that defines the tail piece 8. The web piece 80 anchors the fibers 40, which are either woven into or tied to the web piece 80 and also strengthens the tail 8 against tearing or detachment from the lure 2.

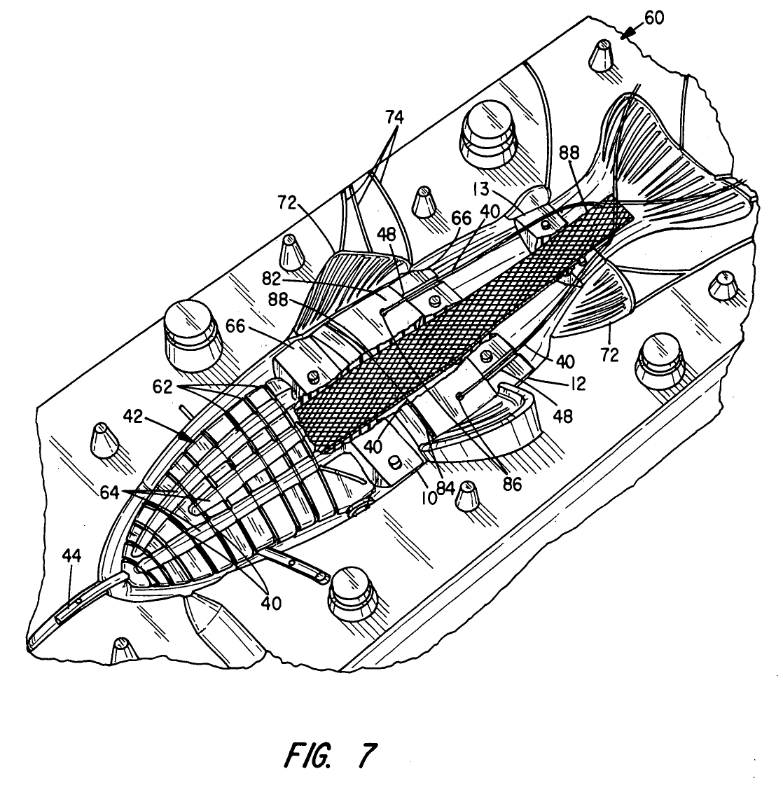

FIG. 7 shows yet another view of a mold half 60 that supports a pair of core pieces 42 and 82 that are interconnected with lengths of pre-wound fiber strands 40. The core pieces 42 and 82 are formed to include recesses 84 and 86 that receive opposite ends of webbed hinge pieces 88 that span the intervening pedestal 62 at the region of the hinge pieces 10 12 and 13. The webbing pieces 88 tend to increase the durability of the coupling between the head and mid-body pieces 4, 6 and 7. A web piece 80 is also used to collect the ends of the fibers 40 at the tail piece 8.

While the invention has been described with respect to considered alternative assemblies and considered improvements or alternatives thereto, still other assemblies may be suggested to those skilled in the art. It is also to be appreciated that selected ones of the foregoing components can be used singularly or can be arranged in different combinations to provide a variety of improved lures. For example, the strands 40 can be bonded to a lure without a core piece 42. High tensile strength woven web pieces 80 can also be positioned in the body to span individual joints and/or multiple body pieces. The fibers 40 can be interconnected with lure attractor and accessory pieces. Hollow chambers, foam, weights, rattle pieces or other attractors, along with a magnetic hook holder, can be integrated into the body. The foregoing description should therefore be construed to include all those embodiments within the spirit and scope of the following claims.

What is claimed is:

1. A fishing lure comprising:
a) a body formed of a resiliently flexible material having a head piece exhibiting a first thickness coupled by an intermediate hinge piece to a trailing piece having a second thickness, wherein said hinge piece is integrally formed with said head and trailing pieces, and wherein the thickness of said hinge piece is less than one-half the thickness of said first or second thicknesses;
b) a fish hook secured to said body; and
c) a plurality of fibrous strands having a tensile strength significantly greater than that of the body material trained through and integrally molded into said head, hinge and trailing pieces and impregnated with said soft plastic material, such that said trailing piece is free to move side-to-side relative to said head piece without separating from said head piece.

2. A fishing lure as set forth in claim 1 wherein said fibrous strands comprise aramid fibers.

3. A fishing lure as set forth in claim 2 wherein said strands are secured to a core piece and said core piece is molded into said body.

4. A fishing lure as set forth in claim 3 wherein said core piece is formed of a plastic material to which said soft plastic material bonds and wherein said core piece comprises a member having a plurality of intersecting longitudinal and transverse channels wherein said fibrous strands are wound into said channels.

5. A fishing lure as set forth in claim 4 wherein said core piece includes a tubular member having a bore that supports a filamentary member shaped to attach to a fish line and to said hook.

6. A fishing lure as set forth in claim 1 molded from a soft plastic polyvinyl chloride (PVC) material.

7. A fishing lure as set forth in claim 1 wherein said hinge piece includes a bore through which at least one of said strands passes.

8. A fishing lure as set forth in claim 1 wherein a plurality of said fibrous strands are trained to overlap each other at said trailing piece.

9. A fishing lure as set forth in claim 1 wherein said lure includes a fibrous woven member is secured to a plurality of said fibrous strands.

10. A fishing lure as set forth in claim 1 wherein a fibrous woven member spans between said head and trailing pieces at said hinge piece.

11. A fishing lure as set forth in claim 1 including a plurality of trailing pieces of successively decreasing thickness and wherein of said trailing pieces is retained to the lure by an intermediate vertical hinge piece containing a plurality of said fibrous strands.

12. A fishing lure comprising:
a) a body formed of a resiliently flexible soft plastic material having a head piece exhibiting a first thickness integrally coupled to a plurality of trailing pieces by a plurality of successive, intermediate vertical hinge pieces that span the body, wherein each of said hinge pieces is integrally formed with said head and trailing pieces, and wherein the thickness of said hinge pieces is less than one-half the thickness of the thickest portion of said body;
b) a fish hook secured to said body; and
c) a plurality of fibrous strands having a tensile strength significantly greater than that of the body material trained through and integrally molded into said head, hinge and trailing pieces and impregnated with said soft plastic material, such that said trailing pieces are free to move side-to-side relative to said head piece without separating from said body.

13. A fishing lure as set forth in claim 12 wherein said fibrous strands comprise aramid fibers and wherein said soft plastic body material comprises a polyvinyl chloride (PVC) material.

14. A fishing lure as set forth in claim 12 wherein said strands are secured to a core piece and said core piece is molded into said body.

15. A fishing lure as set forth in claim 12 wherein said core piece is formed of a plastic material to which said soft plastic material bonds and wherein said core piece comprises a member having a plurality of intersecting longitudinal and transverse channels wherein said fibrous strands are wound into said channels.

16. A fishing lure as set forth in claim 15 wherein said core piece includes a tubular member having a bore that supports a filamentary member shaped to attach to a fish line and to the hook and a magnetic member.

17. A fishing lure as set forth in claim 12 wherein at least one of said hinge pieces includes a bore through which at least one of said strands passes.

18. A fishing lure as set forth in claim 12 wherein a plurality of said fibrous strands are trained to overlap each other at a rearmost trailing piece.

19. A fishing lure as set forth in claim 12 wherein said lure includes a porous, woven fibrous member that spans between at least one of said hinge pieces and the adjacent head and/or trailing piece.

20. A method of constructing a fishing lure comprising:
a) winding a fibrous stranded material having a tensile strength significantly greater than a flexibly resilient molding material into a plurality of channels formed into a core support member and leaving portions of a plurality of said strands dangling from the core member;
b) mounting said core member in a lure mold and training said dangling strand portions over a plurality of cavities in said mold;
c) filling said mold with a soft plastic material to impregnate said fibrous strands; and
d) curing the plastic material and removing a molded lure from said mold.

21. A method as set forth in claim 20 wherein the cavities of said mold define a plurality integral body pieces and intermediate hinge pieces of said lure.

22. A method of constructing a fishing lure comprising:
a) training a plurality of strands of a fibrous material having a tensile strength significantly greater than a flexibly resilient molding material over a plurality of cavities in mold;
b) filling said mold with a soft plastic material to impregnate said fibrous strands; and
c) curing the plastic material and removing a molded lure from said mold.
